(19) United States
(12) Patent Application Publication
(10) Pub. No.: US 2014/0026842 A1
(43) Pub. Date: Jan. 30, 2014

(54) INTEGRALLY CAST MOUNTING PLATE

(71) Applicants: Nagesh Siddabasappa Mavinahally, Northridge, CA (US); Sharu Raigiri, Suwanee, GA (US)

(72) Inventors: Nagesh Siddabasappa Mavinahally, Northridge, CA (US); Sharu Raigiri, Suwanee, GA (US)

(21) Appl. No.: 13/742,334

(22) Filed: Jan. 15, 2013

Related U.S. Application Data
(60) Provisional application No. 61/614,092, filed on Mar. 22, 2012.

(51) Int. Cl. F02B 77/00

(52) U.S. Cl. CPC F02B 77/00
USPC 123/197.4

(57) ABSTRACT

An internal combustion engine having an integral mounting bracket plate and the flywheel housing for mounting the fuel tank. Alternatively, the mounting bracket is integral with the clutch housing. In another embodiment, the fuel tank is mounted on a back pack having a tubular structure and a plate with fins for increasing the surface area of the mounting plate.

### RELATED APPLICATIONS

The present application claims the benefit of priority of U.S. provisional application No. 61/614092, filed Mar. 22, 2012 entitled “INTEGRALLY CAST MOUNTING PLATE” Ser. No. 12/907,360, entitled “INTEGRALLY CAST BLOCK AND UPPER CRANKCASE” which was filed Oct. 19, 2010; Ser. No. 12/876,137, entitled “FOUR CYCLE ENGINE CARBURETORS”, which was filed Sep. 4, 2010; U.S. Provisional Application No. 61/252,685, entitled “INTEGRALLY CAST BLOCK AND GASEOUS FUEL INJECTED GENERATOR ENGINE” filed Oct. 19, 2009; U.S. patent application Ser. No. 12/890,627, entitled “INTEGRALLY CAST BLOCK AND GASEOUS FUEL INJECTED GENERATOR ENGINE”, which was filed Sep. 25, 2010; which are all hereby expressly incorporated by reference herein for all purposes.

### FIELD OF THE INVENTION

The invention relates to internal combustion engines and, more particularly, to integrally cast clutch and/or flywheel housing 600 having the LPG fuel tank mounting plate 604.

### BACKGROUND

Conventional gaseous fueled engines, particularly portable liquefied petroleum gas engines, have fuel tank or pressure regulator or sometimes vaporizers mounted closer to heat sink to receive heat to compensate for latent heat of vaporization of LPG fuel which has a very low boiling temperature at ambient pressure. There are numerous locations on the engine and product that can be used as a heat sink. For example, cooling air, exhaust muffler, crankcase, and cylinder head, etc. can act as heat sink. However, the disadvantage may be that the temperature of the heat sink rises over a period of time and may over heat the LPG tank or the pressure regulator. Second disadvantage, particularly in a portable product, such as a trimmer where the tank is attached to the crankcase as in prior art U.S. Pat. No. 7,424,886, the weight distribution is not optimal from the balance point of view. The added weight is way far from the handle. This forces the user to force the cutting head to be pushed down manually, thus causing fatigue to the user. The embodiment disclosed here overcomes all of the above disadvantages.

In some cases, the fuel tank is attached remotely from the engine, particularly attached to waist belt of the user. The weight of the tank can cause discomfort to the user. Another embodiment disclosed here overcomes such disadvantages. In some other cases, the fuel tank is attached to the boom of the trimmer, which adds weight farther from the handle and is not in an ideal location. Secondly, tank on the boom is farther from the engine to receive any heat for compensation of latent heat of evaporation of fuel.

### PRIOR ARTS

Many prior arts have described the need for heating the fuel tank and or the fuel vaporizer in a LPG fueled engine. Prior arts also disclose different methods of heating the tank and also location of the tank. For example the U.S. Pat. No. 2,895,560 issued in 1957 describes location of the LPG tank and pressure regulator on the top side of hood of the engine. The tank is rigidly mounted on the engine hood by the bracket 19 having curvature same as fuel tank 17 and clamping bands 20. U.S. Pat. No. 5,330,031 issued in 1994 describes mounting of a gaseous fuel tank horizontally outside the engine compartment of a fork lift. U.S. Pat. No. 2,821,259 issued in 1958 describes a mounting bracket for a LPG tank mounted vertically in front of the heat exchanger. The clamp holding the tank is similar to the fastener and the strap used in the prior art U.S. Pat. No. 7,424,886. U.S. Pat. No. 5,606,944 describes heated air circulating around the engine to warm the LPG fuel tank and is mounted horizontally at the back of the engine. In a portable hand-held engine, however, the fuel tank can be mounted on the engine attached to crankcase as disclosed in US publication 20110088650, in which the fuel tank is attached to the crankcase, shown in FIG. 14f, but farther and behind the front main bearing. In that disclosure, the crankcase 44 has curvature that is more or less same as the fuel tank. It also has vibration isolators 44c between the fuel tank and the crankcase 44. In the U.S. Pat. No. 7,424,886, the fuel tank is mounted laterally to one side of the engine, as shown in FIG. 4a, which can off-set the balance tilting the product to one side. In FIG. 10 it is shown to be mounted below the engine, which increases the momentum about the handle where operator holds the trimmer. Also, when the tank is mounted under the crankcase below the engine, it increases the overall height of the product/engine. Thus it is not desirable to have the fuel tank farther from the handle. While all of the different locations disclosed in prior arts transfer heat either through convention or conduction or radiation or combination of all of the three modes of heat transfer. The tank irrespective of where they are mounted on the engine or the product vibrates by the very nature of physics, unless they are isolated to be free of any vibration. Therefore, it is well known that heat and vibration are inherent characteristics of materials and they can be more or less depending on the material used for mounting the fuel tank. It is needless to say man did not invent heat and vibration, but they are taken advantage of to benefit from the natural phenomenon.

### BRIEF SUMMARY OF THE INVENTION

An internal combustion engine, a four-stroke, two-stroke, or rotary engine, having a cooling fan has housing around the fan. Some engines, particularly portable engines such as a trimmer or a blower or a generator engines, have flywheel with magnets act as cooling fan. In some applications, a clutch housing that surrounds the clutch assembly is attached to the flywheel housing. Alternatively, the clutch housing is integral with the flywheel housing. In some products, the flywheel is on one of the engine while the clutch assembly is on the opposite side. The embodiment disclosed here has the fuel tank mounted on the flywheel or the clutch housing. The advantage is that that the weight of the tank is closer to the handle and secondly overall height of the product/engine is significantly lower compared to mounting the tank below the engine.

Yet, in another embodiment, the fuel tank is mounted on to the frame of a backpack. The fuel tank in the backpack can be mounted with outlet facing down for liquid draw or facing up for vapor draw. The fuel supply line has a quick disconnect coupling at the engine and a fuel shut off valve on the backpack. More than one fuel tank can be mounted on to the back pack. The frame of the back pack has a plate attached to the tubular pipes and the plate has fins to increase the surface area for convective heat transfer from ambient to the tank.

### BRIEF DESCRIPTION OF THE DRAWINGS

FIG. 1 is a cross sectional side view illustration of an exemplary embodiment of an internal combustion engine with fuel tank mounted onto the flywheel/clutch housing.

FIG. 1b is a cross sectional side view illustration of an exemplary embodiment of an internal combustion engine with fuel tank mounted onto the boom and clutch housing with a bracket.

FIG. 2 is enlarged view of the bracket shown in FIG. 1.

FIG. 3 is schematic front view of the trimmer shown in FIG. 1.

FIG. 3b is schematic front view of the trimmer shown in FIG. 1b.

FIG. 4 shows schematics of the fuel tank on the back pack and the trimmer.

FIG. 5 shows schematic of the fuel tank on the backpack with outlet facing up for vapor draw.

FIG. 6 shows schematic of the fuel tank on the backpack with outlet facing down for liquid draw.

FIG. 7 shows schematic of the frame and the plate on the back pack.

### DETAILED DESCRIPTION

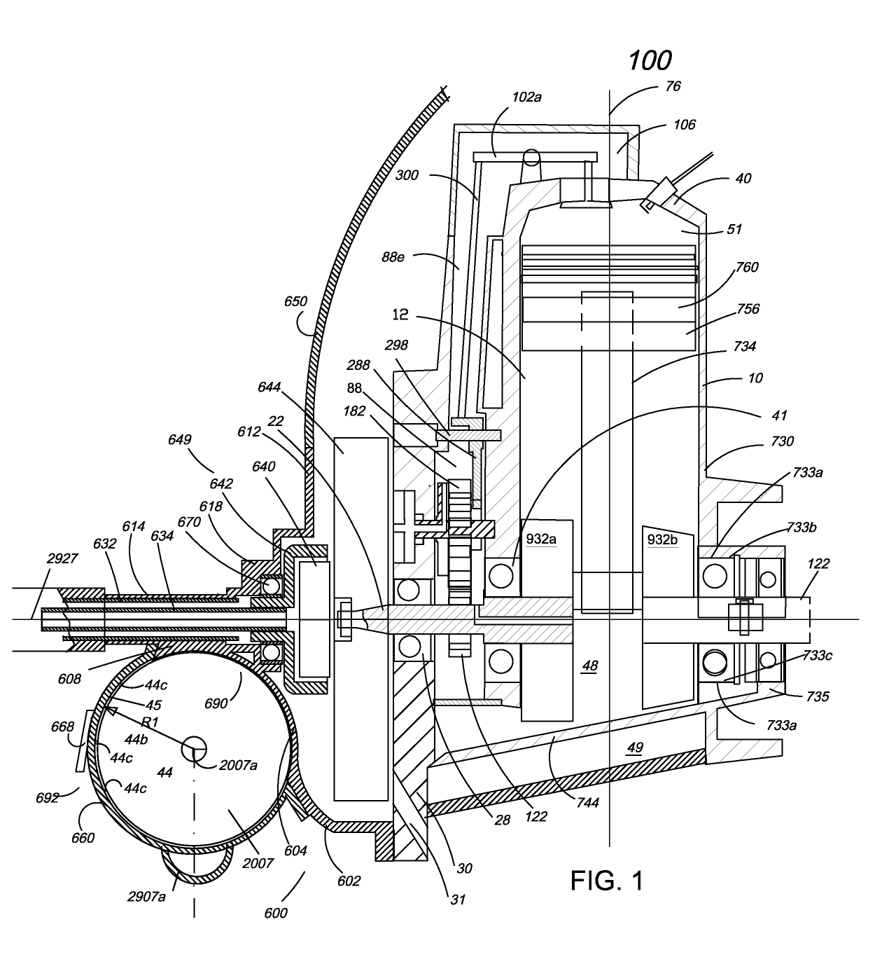

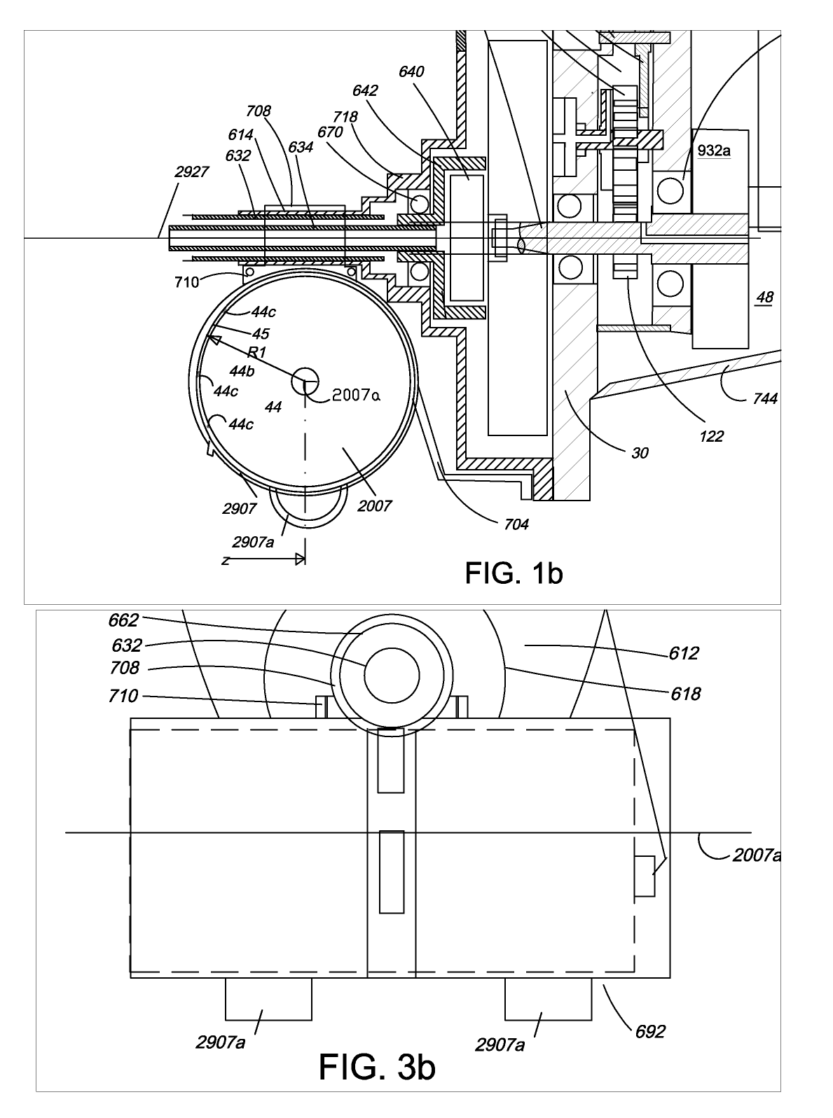

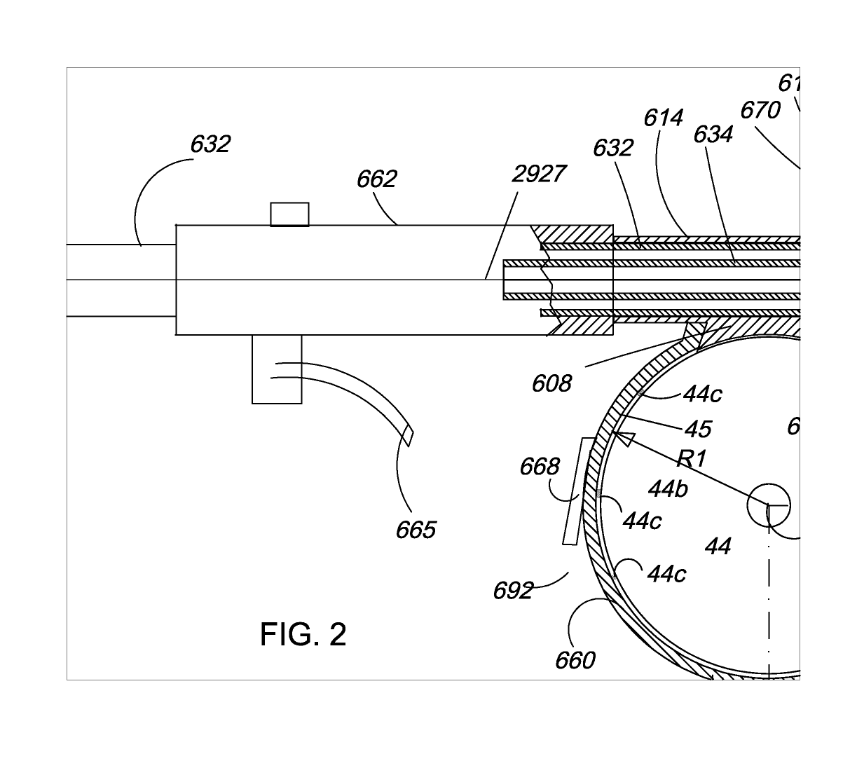

FIGS. 1 and 2 illustrate an exemplary embodiment of an internal combustion engine 10 having a piston 756, engine block 10, crankcase 30, cylinder head 40, crankshaft 22, a connecting rod 734, at least one from bearing 28, crankcase chamber 51. The engine 10 also has a flywheel or a fan 644 in front of the front main bearing 28, mounted on the crankshaft 22. The flywheel 644 may have a clutch assembly 640 and a clutch 642. The clutch 642 in FIG. 1 is shown to be mounted on the clutch housing 649 and supported by the clutch bearing 670. In some engine, the clutch 640 is mounted on the crankshaft 22 and there may be a starter housing downstream of the clutch assembly, as in the case of Homelite trimmer engine. The clutch housing 649 consists of bearing section 618, and the handle section 614. The bearing section 618 may have an insert molded sleeve (not shown) to press fit the clutch bearing 670 onto. If the clutch housing 649 is metal, preferably aluminum or magnesium, then there is no need for sleeve. In some cases the clutch housing 649 is made of molded plastic, which gets warm due to transfer of heat from the engine. The front handle section 614 is an extension of the bearing section and holds the boom 632 of the trimmer. Alternatively it may be integral with the coupling housing (not shown), should the engine be coupled to a generator, water pump, blower etc. The upper section of the clutch housing extends upward to be coupled to the top (top cover 650) engine housing 650. The upper section 612 may be part of the flywheel housing 600, should the product have the flywheel housing 600 and the clutch housing 649 as two or more separate parts, but fastened together. The lower part 602 of the clutch housing 600 is fastened to the crankcase 300. The lower part 602 curves upward and has a curved section 604 continuing to merge with the handle section 608 at the lower side of the clutch housing 649. The curved section 604 of the flywheel housing 600 and curved section 608 on the lower side of the handle section 614 have curvature closely matching the curvature of the fuel tank 2007, similar to the mounting bracket 19 disclosed in U.S. Pat. No. 2,895,560. However, in the exemplary embodiment described here, the bracket (690) is integral with the flywheel housing 600 and or the clutch housing 649. The total combined circumferential length of the curved sections 604 and 608 may be about (more or less) 25% of the circumferential length of the fuel tank 2007. However, it is important to have enough surface area as to transfer the required minimum heat to the tank. The surface area means fractional length of the circumference of the bracket 690 multiplied by the length of the mounting bracket 690 along the axial length of the bracket 690 or the fuel tank 2007. The fuel tank may be in direct contact with the bracket 690 for conductive heat transfer or have dampening blocks, such as element 44c, shown in FIG. 1, for minimizing the vibration of the tank 2007.

The clamping bracket 692 has a cage 660 which is a protective cover fastened to the flywheel housing at section 602 at the lower side, and fastened to the clutch housing at section 608 on the upper side. The cage 660 may also have dampening blocks 44c to minimize the vibration of the tank 2007. The fuel tank 2007 may be held tight in place with a strap 568 similar to clamps disclosed in many prior arts. The cage 660 has a curvature that is closer to the curvature of the fuel tank 2007. The cage 660 has a supporting foot 2907a to support the trimmer or a product when laid down. Alternative to bracket being integral with flywheel housing or clutch housing, a separate detachable bracket may be sandwiched between the crankcase 30 (engine block) and the flywheel housing 602. The bracket material preferable made of metal, which has better heat conducting property. In another embodiment, the bracket may be bolted on to the clutch housing or the flywheel housing.

FIG. 1b shows enlarged view of the bracket and the clutch housing.

The advantage with attaching the LPG fuel tank is that it keeps the flywheel/fan housing 602 cooler and therefore the cooling air circulating through the engine may be cooler than it would be without the fuel tank mounted to the flywheel housing. It is also possible for the cooling air to pass through the cage 692 first then enter the flywheel housing, as disclosed in U.S. patent application No. 61586840. The cooling air may enter the flywheel housing through passage 31 in the crankcase 30 as well as through the center of the flywheel housing. The air may circulate around the fuel tank 2007 before entering the flywheel housing for improved heat transfer between the tank and the air. Conductive heat from flywheel to the tank also lowers the temperature of the flywheel and the crankcase 30.

Engine 10 shown to have an oil tank 49 which can either be a detachable tank or integral with the crankcase 30. However, in a wet sump or mist lubricated engine, there is no spate oil tank 49. In a mist lubricated or dry-sump engine, the oil pump may be driven by the crankshaft or camshaft or a diaphragm pump.

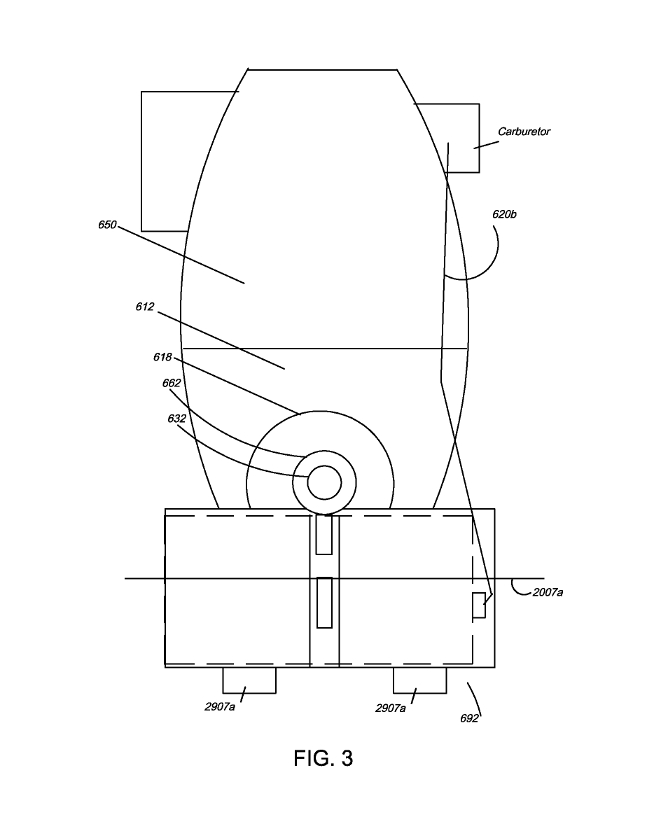

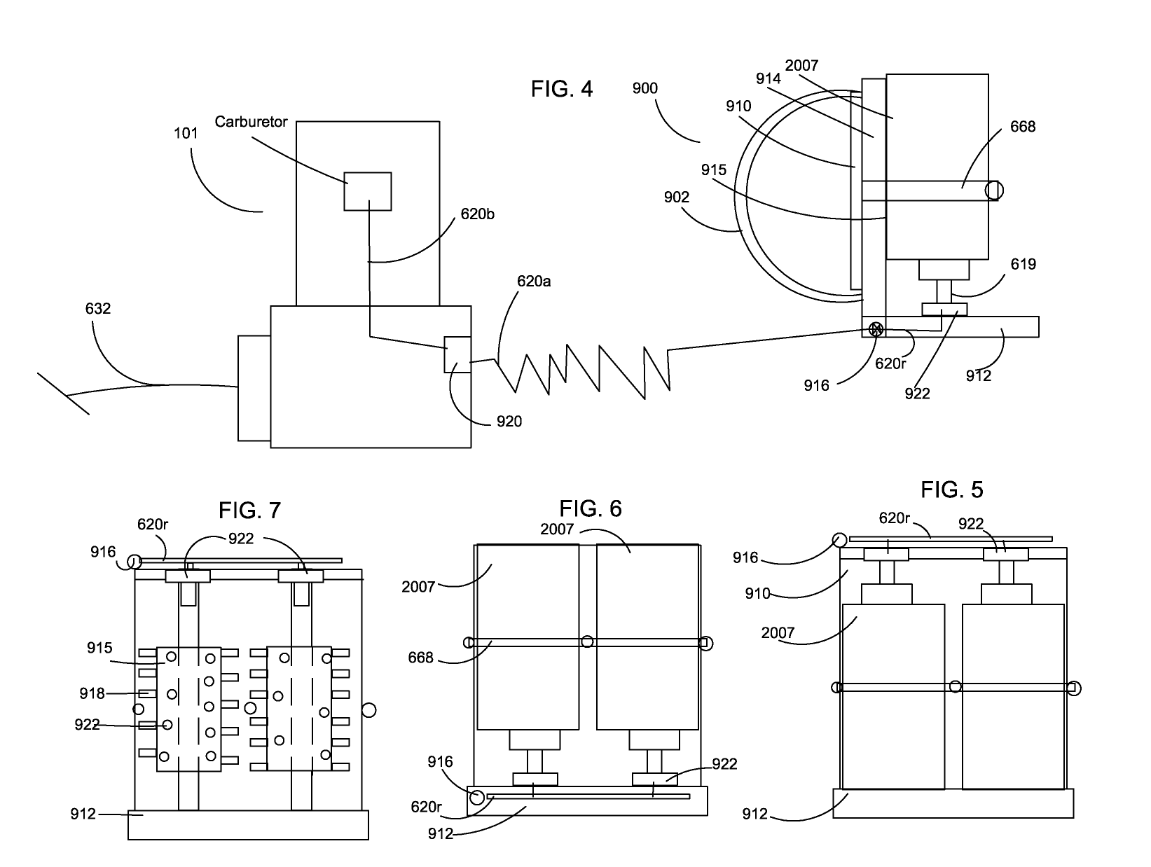

Alternatively, the mounting bracket assembly consisting of the bracket 690 and the cage 660 with the strap 668 may be a separate part attached to the engine as an aftermarket product to convert an existing gasoline engine into an LPG/Butane fueled engine. The separate bracket 704 may be attached at the interface between the clutch housing and the flywheel housing or between the flywheel housing and the crankcase or fastened to the clutch housing as an add-on part, as shown in FIG. 1b and FIG. 3b. The front bracket 704 is clamped on to the boom with an upper bracket 708 that wraps around the handle section 614. In FIG. 1, the axis 2007a of the cylinder tank 2007 is shown to be below the axis 2927 of the engine crankshaft 22. However, it should be understood that the fuel tank 2007 may be mounted above the axis 2927. It may also, sometime, be preferable to have the engine mounted upside down with reference to the boom 632, in which case the engine head is toward the ground. Having the engine 100 upside down may help balance the trimmer much better, while the fuel tank is above the boom 632 for easy loading and unloading the fuel tank 2007. Axis 2007a is substantially perpendicular to the axis 2007. Also, the axis 2007a of the fuel tank is farther toward the front of the engine and may be substantially perpendicular to the axis 76 of the cylinder. In some cases, it is possible for the fuel tank 2007 to be mounted back of the engine.

The axial length of the cage 600 can be equal to or less than the entire length of the fuel tank 2007. The fuel tank 2007 typically can be of 1 pound or so in weight and similar to the disposable propane canisters made by Coleman or smaller canisters made for portable stoves, which are smaller in size and commonly known as butane canisters in Asian countries.

1. An internal combustion engine (100) comprising:
a engine block (10);
a crankshaft (22) having a counter weight (932);
a piston (756) connected to the crankshaft (22) through a connecting rod (734);
a combustion chamber (51);
a crankcase (30);
at least one outer bearing (28);
a flywheel (644);
a flywheel housing (600);
a section (602) of the flywheel housing (600) has a curved section (604) to match a fractional section of the fuel tank 2007;
a gaseous fuel tank 2007 is rigidly attached to the bracket 690;
a wrap around strap 668 rigidly clamps the fuel tank 2007 to the bracket 690; and
flywheel housing 600 is attached to the engine 100.

2. A internal combustion engine (100) as claimed in claim 1 has clutch housing 649.

3. A clutch housing (649) as claimed in claim 2 is integral with the flywheel housing 600.

4. An internal combustion engine (101) having a back pack (900) for mounting LPG tank (2007) comprising:
A back pack with a frame (914) and fuel tank (2007) mounted to the frame (914).

5. An internal combustion engine (100) comprising:
a engine block (10);
a crankshaft (22) having a counter weight (932);
a piston (756) connected to the crankshaft (22) through a connecting rod (734);
a combustion chamber (51);
a crankcase (30);
at least one outer bearing (28);
a flywheel (644);
a mounting bracket 704 mounted to the flywheel housing;
an upper bracket 708 attached to the front handle section (614);
axis 2007a is below the axis 2927 and substantially perpendicular to each other;
a gaseous fuel tank 2007 is rigidly attached to the bracket 704;
a wrap around strap 668 rigidly clamps the fuel tank 2007 to the bracket 704; and
flywheel housing 600 is attached to the engine 100.
